(19) United States
(12) Patent Application Publication
(10) Pub. No.: US 2017/0312744 A1
(43) Pub. Date: Nov. 2, 2017

(54) METAL DEPOSITION USING POTASSIUM IODIDE FOR PHOTOCATALYSTS PREPARATION

(71) Applicant: SABIC Global Technologies B.V., Bergen op Zoom (NL)

(72) Inventors: Hamdan Ahmed Alghamdi, Thuwal (SA); Habib Katsiev, Thuwal (SA); Hicham Idriss, Thuwal (SA)

(73) Assignee: SABIC Global Technologies B.V., Amsterdam (NL)

(21) Appl. No.: 15/528,855

(22) PCT Filed: Dec. 29, 2015
(86) PCT No.: PCT/IB2015/060030

§ 371 Date: May 23, 2017

Related U.S. Application Data
(60) Provisional application No. 62/099,799, filed on Jan. 5, 2015.

(51) Int. Cl. B01J 35/00; B01J 23/52; B01J 37/22; C01B 13/02; C01B 3/04; B01J 19/12; B01J 23/42; B01J 35/02

(52) U.S. Cl. CPC B01J 35/004; B01J 23/42; B01J 23/52; B01J 35/0033; B01J 35/023; C01B 13/0207; C01B 3/042; B01J 19/123; B01J 37/22; B01J 2219/0892; B01J 2219/1203; C01B 2203/1041; C01B 2203/107; B01J 2219/0877

(57) ABSTRACT

Photocatalysts and methods of using photocatalysts for producing hydrogen and oxygen from water are disclosed. The photocatalysts include an iodide modified photoactive material having an electrically conductive material attached to the iodide ions.

### CROSS REFERENCE TO RELATED APPLICATIONS

This application claims priority to U.S. Provisional Application No. 62/099,799, filed Jan. 5, 2015. The contents of the referenced application are incorporated into the present application by reference.

### BACKGROUND OF THE INVENTION

### A. Field of the Invention

The invention generally concerns photocatalysts that can be used to produce hydrogen from water in photocatalytic reactions. The photocatalysts include an iodide modified photoactive material and a charged electrically conductive material.

### B. Description of Related Art

Hydrogen production from water offers enormous potential benefits for the energy sector, the environment, and the chemical industry (See, for example, Kodama & Gokon, Chem. Rev., 2007, Vol. 107, p. 4048; Connelly & Idriss, Green Chemistry, 2012, Vol. 14, p. 260; Fujishima & Honda, Nature 238:37, 1972; Kudo & Miseki, Chem. Soc. Rev 38:253, 2009; Nadeem, et al., Int. J. Nanotechnology, 2012, Vol. 9, p. 121; Maeda, et al., Nature 2006, Vol. 440, p. 295). While methods currently exist for producing hydrogen from water, many of these methods can be costly, inefficient, or unstable. For instance, photoelectrochemical (PEC) water splitting requires an external bias or voltage and a costly electrode (e.g., Pt-based).

Many advancements in the area of photocatalytic water-splitting to produce hydrogen and oxygen has been achieved, however, many materials are either unstable under realistic water splitting conditions or require considerable amounts of other components to work, thereby offsetting any gained benefits. One advancement in this area is the use of semiconductor photocatalysts such as titanium dioxide (TiO₂) for H₂ and O₂ production from water or biofuels. Semiconductor photocatalysts can absorb electromagnetic radiation having energy greater than the energy band gap (E>Eg), which promotes electrons from the valence band (VB) of the semiconductor material into the conduction band (CB) of the semiconductor material, giving rise to electron-hole pairs (e−-h+). The electrons and holes can migrate to the surface of semiconductor particles and participate in surface reduction or oxidation reactions, or recombination reactions. To be an effective photocatalyst for H₂ production, the valence band of a semiconductor must be more positive than the O₂/H₂O redox couple (+1.23 V versus normal hydrogen electrode (NHE)), and the conduction band must be more negative than the H₂O/H₂ redox couple (0 V). Many semiconductors satisfy both these criteria, but many are unstable, and the efficiencies of the stable semiconductors (for example, TiO₂) are low due to many factors including the following: (1) rapid recombination of photo-generated electrons and holes; (2) fast back reaction between hydrogen and oxygen to form H₂O, and (3) the large over potential for hydrogen production on the titanium dioxide surface. Attempts to remedy these problems involve modification of the surface of the semiconductors with noble metals (such as Pt, Au, Pd or Ni) or semiconductors (such as CuO) that can accept photo-excited electrons from the conduction band of the semiconductor or catalyze recombination of hydrogen atoms to form hydrogen (See, for example, Joo et al. in PNAS, 2014, Vol. 111, pp. 7942-7947). The role of the metal is, however, not well understood. In many catalysts there is a narrow concentration range for the metals on the surface of the semi-conductor to obtain high rates. This range is typically between 0.1 and 1 wt % of the deposited metal after which the rate starts to decrease. The decrease in the reaction rate with increasing the amount of metal may be explained as due to the increasing number of defects at the interface metal/semiconductor therefore acting as charge carriers traps and consequently decrease their availability to reduce hydrogen cations and oxidize oxygen anions. Also, the addition of sacrificial hole scavengers such as ethanol or methanol can be used to facilitate charge separation in the semiconductor and enhance the hydrogen gas yield. (See, for example, Chen et al., in International Journal of Hydrogen Energy, 2013, Vol. 38, pp. 15036-15048).

In the photocatalytic electrolysis of water, some modified semiconductors demonstrate acceptable results the photocatalytic electrolysis of water. Many of these catalysts, however, suffer from poor dispersion of the metal particles on the semiconductor surface, which leads to inefficient production of hydrogen. (See, for example, Chen et al. Journal of Catalysis, 2013, 305, pp. 307-317). The poor dispersion can be due in part to the tendency of some metal (for example, silver and gold) to agglomerate and form large particles, thus decreasing their dispersion. The poor dispersion can also be attributed to the calcination temperature needed to transform metal oxides to metals. The current methods also suffer from the requirement that the metals be in their elemental state prior to use, and, thus the photocatalyst prepared from metal cations must undergo a reduction process (for example, thermal heating or calcination process) to reduce the metal cations to their elemental state.

### SUMMARY OF THE INVENTION

A solution to the aforementioned inefficiencies surrounding current water-splitting photocatalysts has been discovered. In particular, the solution resides in a photoactive material that provides more efficient production of hydrogen and oxygen from water-splitting reactions as compared similar photocatalysts (for example, Au/TiO₂ catalysts). The enhancement is due to the ability to disperse nanometer or sub-nanometer particles of electrically conductive material on the surface of a photoactive material modified with iodide ions. Without wishing to be bound by theory, it is believed that the improved dispersion and smaller sized particles is due to the iodide ions inhibiting the agglomeration of electrically conductive material (for example, gold cations), which results in smaller particles of electrically conductive material being adsorbed on the surface of the iodide modified titanium dioxide. Notably, it has been discovered that the smaller nanoparticles allow for catalysis of molecular hydrogen production from hydrogen atoms without decreasing the availability of charge carriers (electron-hole pairs). It has also been discovered that the size of electrically conductive material can be tuned by adjusting the contact time of iodide modified photoactive material with the metal ions, with the shortest amount of contact time producing the smallest electrically conductive material particles. Without wishing to be bound by theory, it is believed that the electrically conductive material catalyzes the production of molecular hydrogen from the hydrogen atoms (or ions) that have been generated during the photocatalytic water-splitting reaction and are present on the semiconductor surface.

The use of iodide modified photocatalytic material result in more efficient production of hydrogen and oxygen production from water as compared to a photocatalyst prepared with a noble metal deposited on its surface by other methods. The improved efficiency of the photocatalyst of the present invention allows lower amounts of noble metals (e.g., lower loading amount) to be used and a reduced reliance on additional materials such as the use of sacrificial agents, thereby decreasing the complexity and costs associated with using the photocatalysts in water-splitting applications and systems. Notably, the use of iodide ions also eliminates the need for high temperature treatment of the noble metal cations to metals prior to use. Without wishing to be bound by theory it is believed that the use of iodide ion may allow the noble metals (for example, gold) to exist in more than one oxidation state.

Hydrogen and oxygen production in photocatalytic water-splitting reactions can be further enhanced by using titanium dioxide particles having rutile, anatase, and brookite phases in the semiconductor material. The titanium dioxide particles can be a mixture of rutile and anatase titanium particles or a mixed phase titanium particle having anatase and rutile phases. Without wishing to be bound by theory, it is believed that when rutile nanoparticles are formed on the surface of the single phase anatase nanoparticles, the electron-hole recombination rate is retarded due to electron transfer from the rutile to the anatase phase. In other words, because the electron-hole recombination rate is fast in rutile and slow in anatase (See, for example, Xu, et al. in Topological Features of Electronic Band Structure and Photochemistry: New Insights from Spectroscopic Studies on Single Crystal Titania Substrates. Physics Review Letters 2011, Vol. 106, pp. 138302-1 to 138302-4) and because the number of electron and holes is higher in rutile than in anatase at a given wavelength capable of exciting both materials, the mixture performs better in photocatalytic water-splitting reactions. The materials benefit from a large number of carriers (in rutile) and a slow rate of recombination (in anatase) giving them more time to make the reduction of hydrogen ions to hydrogen molecules and the oxidation of oxygen ions to oxygen molecules. Thus, a titanium dioxide photocatalyst of the present invention combines a metal-semiconductor interface with the synergistic effect of anatase and rutile phases in the titanium dioxide.

In one particular aspect of the invention, a photocatalyst includes a photoactive material comprising titanium dioxide and iodide ions attached to the surface of the titanium dioxide; and an electrically conductive material attached to the halide ions. In a preferred aspect, the halide ions are iodide ions. In some aspects, the titanium dioxide includes one or more phases, for example, anatase, rutile, brookite, or a mixture thereof. In a particular aspect, the titanium dioxide includes single phase anatase. In embodiments when the titanium dioxide includes mixed phases of anatase and rutile, the ratio of anatase to rutile ranges from 1.5:1 to 10:1, preferably 3:1 to 6:1, and most preferably from, 4:1 to 5:1. The photoactive material can be subjected to an iodide solution to obtain the iodide ions attached to the surface of the photoactive material. In some embodiments, titanium dioxide is subjected to a Group IA metal halide solution, preferably an iodide ion. The electrically conductive material includes a metal, or more preferably, a noble metal. Non-limiting embodiments of metals include gold, ruthenium, rhenium, rhodium, palladium, silver, osmium, iridium, platinum, or combinations thereof. In certain instances, the electrically conductive material is gold, palladium, or both. In some instances, the electrically conductive material is gold particles having an average particle size of ≦1 nm to 10 nm. The photocatalyst can include less than 1 wt. %, or 0.1 to 0.9 wt. %, or 0.3 to 0.7 wt. %, or 0.5 to 0.6 wt. %, or preferable from 0.1 to 0.2 wt. % of the gold based on the total weight of the catalyst. In certain instances, the photoactive material does not cover more than 10, 5, 2, or 1% of the surface area of the photoactive material and still efficiently produce hydrogen from water. The use of gold has been found to be particularly advantageous, as gold can conduct excited electrons away from their corresponding holes in the photoactive material and “trap” them at the photocatalyst surface. These metals can also catalyze hydrogen-hydrogen recombination to hydrogen molecules. Gold also enhances performance via resonance plasmonic excitation from visible light, thus allowing the photocatalyst to capture a broader range of light energy. The gold can act as a sink for transferred electrons from the conduction band and it contributes by its plasmon response in response to visible light in the electron transfer reaction. In particular embodiments, the electrically conductive material is in the form of nanostructures. The nanostructures can be nanoparticles having an average particle size of <1 nm to 25 nm, preferable 0.5 nm to 20 nm, or most preferably 1 nm to 10 nm. The nanostructures can be nanowires, nanoparticles, nanoclusters, or nanocrystals, or combinations thereof. The photocatalyst can be in particulate form or powdered form. In a particular embodiment, the photocatalyst is not subjected to a calcination treatment. The photocatalyst can be self-supported (i.e., it is not supported by a substrate) or it can be deposited onto a substrate. Non-limiting embodiments of substrates include glass, polymer beads or other metal oxides such as indium tin oxide substrate, a stainless steel substrate, silicon oxide, aluminum oxide, zirconium oxide, or magnesium oxide. The photocatalysts of the present invention are capable of splitting water in combination with a light source. No external bias or voltage is needed to efficiently split water. The hydrogen production rate from water can be modified as desired by increasing or decreasing the amount of light from the light flux directed to the system. In particular aspects, the photocatalysts of the present invention can be used in water splitting systems to provide a hydrogen production rate from water between 200 to 1500 μmol/g_{Catal} min, 50 to 1300 μmol/g_{Catal} min, or 60 to 1000 μmol/g_{Catal} min with a light source having an ultraviolet flux from about 0.1 to 30 mW/cm² at 360 nm. In addition to being capable of catalyzing water splitting without an external bias or voltage, the photocatalysts of the present invention can be included in an anode of an electrochemical cell capable of forming oxygen and hydrogen by electrolysis of water. In some instances, the photocatalysts of the present invention are capable of catalyzing the photocatalytic oxidation of an organic compound.

Also disclosed is a composition containing a photocatalyst of the invention, water, and a sacrificial agent that can be used for water splitting. With a light source, the water can be split and hydrogen and oxygen gas formation can occur. In particular instances, the sacrificial agent may further prevent electron/hole recombinations. In some instances, the composition contains 0.01 to 5 g/L, 0.05 to 2 g/L, or 0.1 to 1 g/L of the photocatalyst. Notably, the efficiency of the photocatalysts of the present invention allows for one to use substantially low amounts (or none at all) of sacrificial agent when compared to known systems. In particular instances, 0.1 to 10 w/v %, or preferably 2 to 7 w/v %, of the sacrificial agent can be included in the composition. Non-limiting embodiments of sacrificial agents that can be used include methanol, ethanol, propanol, butanol, iso-butanol, methyl tert-butyl ether, ethylene glycol, propylene glycol, glycerol, oxalic acid, trimethyl amine, triethanolamine, or any combination thereof. In particular aspects, ethylene glycol, glycerol, or a combination thereof is used.

In another aspect of the present invention there is disclosed a system for producing hydrogen gas and/or oxygen gas from water. The system can comprise a container and a composition that includes a photocatalyst of the present invention, water, and optionally a sacrificial agent. The container in particular embodiments is transparent or translucent. Containers can also include opaque containers such as those that can magnify light (e.g., opaque container having a pinhole(s)). The system can also include a light source for irradiating the composition. The light source can be natural sunlight or can be from a non-natural or artificial source such as a UV lamp or UV/visible lamp. While the system can use an external bias or voltage, such an external bias or voltage is not needed due to the efficiency of the photocatalysts of the present invention.

In another embodiment, there is disclosed a method for producing hydrogen gas by photocatalytic electrolysis, the method comprising irradiating an aqueous electrolyte solution comprising any of the compositions described above with light in an electrolytic cell having an anode and a cathode, the anode comprising any of the photocatalysts described above, whereby a voltage between the anode and the cathode is produced and water molecules are split to form hydrogen and oxygen. The method can be practiced such that the hydrogen production rate from water can be modified as desired by increasing or decreasing the amount of light or light flux directed to the system. In particular aspects, the method can be practiced such that the hydrogen production rate from water is between 200 to 1500 μmol/g_{Catal} min, preferably 50 to 1500 μmol/g_{Catal} min using a light source having a flux from about 0.1 to 30 mW/cm² at 360 nm. In some aspects, the ratio of H₂ to CO₂ produced is from 8 to 50. In particular embodiments, the light source can be natural sunlight. However, non-natural or artificial light sources (e.g., ultraviolet lamp, infrared lamp, etc.) can also be used alone or in combination with said sunlight.

In another aspect of the present invention there is disclosed a method of making the photocatalyst of the present invention. The method can include obtaining an iodide treated titanium dioxide having iodide ions attached to the surface of the titanium dioxide; and treating the iodide treated titanium dioxide with a metal salt solution comprising a metal salt solubilized in a solvent to form metal cations attached to the iodide ions on the titanium dioxide to obtain the photocatalyst of the present invention. The iodide modified titanium dioxide can be suspended in a metal salt solution for 30 seconds to 60 minutes, preferably from 45 seconds to 30 minutes, more preferably from 1 minute to 25 minutes, and most preferably from 1 minute to 10 minutes. As previously noted, the size of the metal cation particle can be tuned by adjusting the time that the iodide modified titanium dioxide is contacted (treated) with the metal salt solution. A short contact time of less than 10, 5, 1, or 0.5 minutes can produce sub-nanometer and/or nanometer particles attached to the iodide ions. In some aspects, a particle size of the metal cation can be proportional to the amount of time the titanium dioxide is suspended in the metal salt solution. In a particular aspect, the amount of time can be 1 to 5 minutes to produce a metal cation having a particle size of <1 to 5 nm. Longer contact times result in nanometer or larger particles attached to the iodide ions. Without wishing to be bound by theory, it is believed that removal of the photocatalyst from the metal cation solution slows or stops the growth of the metal cation; therefore inhibiting agglomeration of the metal cations. In one aspect, 1 to 5 grams of iodide modified titanium dioxide can be suspended in 100 to 1000 mL of the metal salt solution. A concentration of iodide treated titanium dioxide to metal salt solution can range from 0.001 to 0.05 g/mL, 0.005 to 0.04 g/mL, or 0.01 to 0.02 g/mL. The metal salt can include any of the metals described throughout the specification. In one particular instance, the metal salt solution is an aqueous solution of hydrogen tetrachloraurate (HAuCl₄). The photocatalyst can be separated from the metal salt solution using known separation methods such as vacuum filtration, centrifugation, gravity filtration, or the like, and dried at temperatures of 200° C. or less, 100° C. or less, preferably at 70° C. The iodide modified titanium dioxide can be obtained by modifying titanium dioxide with an iodide solution that includes iodide ions solubilized in a second solvent for 1 to 48 hours, preferably 12 to 36 hours, or more preferably for 20 to 30 hours. The iodide solution can include 500 mg to 2000 mg of iodide are dissolved in 100 mL to 1000 mL of the second solvent, and 1.5 g to 15 g of titanium dioxide are suspended in the iodide solution. A ratio of titanium dioxide to iodide can range from 0.5:1 to 50:1, 3:1 to 20:1, 7:1 to 10:1, or from 3:1 to 7.5:1. A total concentration of iodide to and titanium dioxide in the second solvent can range from 0.002 to 0.02 g/mL, or from 0.01 to 0.01 g/mL. The source of iodide can be hydroiodic acid (HI) or one or more Group IA metal iodides. Non-limiting embodiments of Group IA metals include lithium, sodium, potassium, rubidium, cesium, or any combination thereof. In a particular instance, an aqueous solution of potassium iodide is mixed with titanium dioxide particles. After treatment, the iodide modified titanium dioxide can be separated from the iodide solution using known separation methods such as vacuum filtration, centrifugation, gravity filtration, or the like. The iodide modified titanium dioxide can be used directly or dried and stored for later use.

Also disclosed in the context of the present invention are embodiments 1 through 56. Embodiment 1 is a photocatalyst comprising: a) a photoactive material comprising titanium dioxide and iodide ions attached to the surface of the titanium dioxide; and b) an electrically conductive material attached to the iodide ions. Embodiment 2 is the photocatalyst of embodiment 1, wherein the electrically conductive material is gold. Embodiment 3 is the photocatalyst of embodiment 2, wherein the gold is gold cations and ionic bonds are formed between the iodide ions and gold cations. Embodiment 4 is the photocatalyst of embodiment 3, comprising less than 1 wt. % of gold, preferable from 0.1 wt. % to 0.9 wt. % of gold, more preferable from 0.1 wt. % to 0.2 wt. %. Embodiment 5 is the photocatalyst of embodiment 4, wherein the gold is in the form of particles having an average particle size of ≦1 nm to 10 nm. Embodiment 6 is the photocatalyst of embodiment 1, wherein the titanium dioxide comprises anatase, rutile, brookite or a mixture thereof. Embodiment 7 is the photocatalyst of embodiment 6, wherein the titanium dioxide comprises single phase anatase. Embodiment 8 is the photocatalyst of embodiment 6, wherein the titanium dioxide comprises anatase and rutile. Embodiment 9 is the photocatalyst of embodiment 6, wherein the ratio of anatase to rutile ranges from 1.5:1 to 10:1, preferably 3:1 to 6:1, and most preferably from, 4:1 to 5:1. Embodiment 10 is the photocatalyst of any one of embodiments 1 and 6 to 9, wherein the electrically conductive material comprises a metal. Embodiment 11 is the photocatalyst of embodiment 9, wherein the metal is gold, ruthenium, rhenium, rhodium, palladium, silver, copper, osmium, iridium, platinum, or combinations thereof. Embodiment 12 is the photocatalyst of embodiment 10, wherein the metal is gold, palladium, or a combination thereof. Embodiment 13 is the photocatalyst of any one of embodiments 1 to 12, wherein the photocatalyst is in particulate or powdered form. Embodiment 14 is the photocatalyst of any one of embodiments 1 to 13, wherein the electrically conductive material is a plurality of nanostructures. Embodiment 15 is the photocatalyst of embodiment 14, wherein the nanostructures are nanoparticles having an average particle size of ≦1 nm to 25 nm, preferable 0.5 nm to 20 nm, or most preferably 1 nm to 10 nm. Embodiment 16 is the photocatalyst of embodiments 14 or 15, wherein the size of the electrically conductive material is tuned by adjusting a contact time of the photoactive material with a solution of the electrically conductive material. Embodiment 17 is the photocatalyst of any one of embodiments 1 to 16, wherein the photocatalyst is comprised in a composition that includes water. Embodiment 18 is the photocatalyst of embodiment 17, wherein the composition further comprises a sacrificial agent. Embodiment 19 is the photocatalyst of embodiment 18, wherein the sacrificial agent is methanol, ethanol, propanol, iso-propanol, n-butanol, iso-butanol, ethylene glycol, propylene glycol, glycerol, oxalic acid, trimethyl amine, triethanolamine, or any combination thereof. Embodiment 20 is the photocatalyst of embodiment 19, wherein the sacrificial agent is ethanol or ethylene glycol. Embodiment 21 is the photocatalyst of any one of embodiments 18 to 20, wherein the composition comprises 0.01 to 5 g/L of the photocatalyst and/or 0.1 to 5 vol. % of the sacrificial agent. Embodiment 22 is the photocatalyst of any one of embodiments 1 to 21, wherein the photocatalyst is self-supported. Embodiment 23 is the photocatalyst of any one of embodiments 1 to 22, wherein the photocatalyst is supported by a substrate such as glass, polymer beads, or other metal oxides. Embodiment 24 is the photocatalyst of any one of embodiments 1 to 23, wherein the photocatalyst is capable of catalyzing the photocatalytic electrolysis of water. Embodiment 25 is the photocatalyst of embodiment 24, wherein the H₂ production rate from water is 200 to 150 μmol/g_{Catal} min, preferably 50 to 150 μmol/g_{Catal} min using a light source having a flux from about 0.1 to 10 mW/cm² at 360 nm. Embodiment 26 is the photocatalyst of any one of embodiments 1 to 25, wherein the titanium dioxide has been subjected to an iodide solution to obtain the iodide ions attached to the surface of the titanium dioxide. Embodiment 27 is the photocatalyst of embodiment 26, wherein the iodide solution comprises a Group IA metal iodide dissolved in water. Embodiment 28 is the photocatalyst of any one of embodiments 1 to 27, wherein the photocatalyst has not been subjected to a calcination treatment.

Embodiment 29 is a system for producing hydrogen gas and oxygen gas from water, the system comprising: (a) a transparent container comprising a composition that includes the photocatalyst of any one of embodiments 1 to 28, water, and a sacrificial agent; and (b) a light source for irradiating the composition. Embodiment 30 is the system of embodiment 29, wherein the light source is sunlight. Embodiment 31 is the system of embodiment 29, wherein the light source is an ultra-violet or an ultra-violet/visible lamp. Embodiment 32 is the system of any one of embodiments 29 to 31, wherein an external bias is not used to produce the hydrogen gas and oxygen gas.

Embodiment 33 is a method for producing hydrogen gas and oxygen gas from water, the method comprising obtaining a system of any one of embodiments 29 to 32 and subjecting the composition to the light source for a sufficient period of time to produce hydrogen gas and oxygen gas from the water. Embodiment 34 is the method of embodiment 33, wherein an external bias is not used to produce the hydrogen gas and oxygen gas. Embodiment 35 is the method of any one of embodiments 33 to 34, wherein the H₂ production rate from water is 20 to 100 μmol/g_{Catal} min, preferably 30 to 95 μmol/g_{Catal} min. Embodiment 36 is the method of any one of embodiments 33 to 35, wherein the light source has a flux between about 0.1 mW/cm² and 30 mW/cm².

Embodiment 37 is a method of making any one of the photocatalysts of embodiments 1 to 28, the method comprising: a) obtaining an iodide modified titanium dioxide having iodide ions attached to the surface of the titanium dioxide; and b) treating the iodide modified titanium dioxide with a metal salt solution comprising a metal salt solubilized in a solvent to form metal cations attached to the iodide ions to obtain any one of the photocatalysts of embodiments 1 to 27. Embodiment 38 is the method of embodiment 37, wherein the iodide treated titanium dioxide is suspended in the metal salt solution for 30 seconds to 60 minutes, preferably from 45 seconds to 30 minutes, more preferably from 1 minute to 25 minutes, and most preferably from 1 minute to 10 minutes. Embodiment 39 is the method of embodiment 38, wherein a particle size of the metal cation is proportional to the amount of time the titanium dioxide is suspended in the metal salt solution. Embodiment 40 is the method of embodiment 39, wherein the amount of time is 1 to 5 minutes and a particles size of the metal cation is ≦1 nm to 10 nm. Embodiment 41 is the method any one of embodiments 37 to 41, wherein 1 to 5 grams of iodide treated titanium dioxide is suspended in 100 to 1000 mL of the metal salt solution. Embodiment 42 is the method of any one of embodiments 37 to 41, wherein the metal salt is a salt comprising gold, ruthenium, rhenium, rhodium, palladium, silver, copper, osmium, iridium, platinum, or combinations thereof. Embodiment 43 is the method of embodiment 42, wherein the metal salt is HAuCl₄. Embodiment 44 is the method of any one of embodiments 37 to 43, wherein the solvent comprises water. Embodiment 45 is the method of any one of embodiments 37 to 44, wherein the produced photocatalyst is separated from the metal salt solution. Embodiment 46 is the method of embodiment 45, wherein the produced photocatalyst is separated from the metal salt solution by vacuum filtration. Embodiment 47 is the method of any one of embodiments 37 to 46, wherein the iodide treated titanium dioxide from step a) is obtained by treating titanium dioxide with an iodide solution comprising an iodide solubilized in a second solvent to form iodide ions attached to the surface of the titanium dioxide. Embodiment 48 is the method of embodiment 47, wherein the titanium dioxide is suspended in the iodide solution for 1 to 48 hours, preferably 12 to 36 hours, or more preferably for 20 to 30 hours. Embodiment 49 is the method of any one of embodiments 47 to 48, wherein 500 mg to 2000 mg of iodide are dissolved in 100 mL to 1000 mL of the second solvent, and 1.5 g to 15 g of titanium dioxide are suspended in the iodide solution. Embodiment 50 is the method of any one of embodiments 48 to 49, wherein the iodide is hydrogen iodide (HI) or one or Group IA metal iodides. Embodiment 51 is the method of embodiment 47, wherein the iodide is a Group IA metal iodide selected from the group consisting essentially of lithium iodide (LiI), sodium iodide (NaI), potassium iodide (KI), rubidium iodide (RbI), or cesium iodide (CsI), and any combination thereof. Embodiment 52 is the method of embodiment 51, wherein the Group IA metal iodide is potassium iodide (KI). Embodiment 53 is the method of any one of embodiments 47 to 52, wherein the second solvent comprises water. Embodiment 54 is the method of any one of embodiments 47 to 53, wherein the iodide treated titanium dioxide is separated from the iodide solution. Embodiment 55 is the method of embodiment 54, wherein the iodide treated titanium dioxide is separated from the iodide solution by vacuum filtration. Embodiment 56 is the method of any one of embodiments 37 to 55, wherein the produced photocatalyst is not subjected to a calcination treatment.

“Water splitting” or any variation of this phrase describes the chemical reaction in which water is separated into oxygen and hydrogen.

“Inhibiting,” “preventing,” or “reducing” or any variation of these terms, when used in the claims or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole. In either instance, the photocatalysts of the present invention can be compared with photocatalysts that do not have an iodide ion interface.

“Effective” or any variation of this term, when used in the claims or specification, means adequate to accomplish a desired, expected, or intended result.

“Nanostructure” refers to an object or material in which at least one dimension of the object or material is equal to or less than 100 nm (e.g., one dimension is 1 to 100 nm in size). In a particular aspect, the nanostructure includes at least two dimensions that are equal to or less than 100 nm (e.g., a first dimension is 1 to 100 nm in size and a second dimension is 1 to 100 nm in size). In another aspect, the nanostructure includes three dimensions that are equal to or less than 100 nm (e.g., a first dimension is 1 to 100 nm in size, a second dimension is 1 to 100 nm in size, and a third dimension is 1 to 100 nm in size). The shape of the nanostructure can be of a wire, a particle, a sphere, a rod, a tetrapod, a hyper-branched structure, or mixtures thereof.

“Sub-nanostructure” or “sub-nanoparticle” refers to an object or material in which at least one dimension of the object or material is equal to or less than 1 nm. In a particular aspect, the sub-nanoparticle has particle size less than 1 nm.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts or photoactive materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1 is a non-limiting schematic of the photocatalyst of the present invention.

FIG. 2A is a non-limiting schematic of a water-splitting system employing the photocatalyst of the present invention.

FIG. 2B is a non-limiting schematic of a water-splitting pathway for production of hydrogen and oxygen using the photocatalyst of the present invention.

FIG. 2C is a non-limiting schematic of another water-splitting pathway for production of hydrogen and oxygen using the photocatalyst of the present invention.

FIG. 3 are spectra of UV-Vis absorption of photocatalysts of the invention.

FIG. 4 is a graph of hydrogen production versus time that the iodide treated TiO₂ (anatase) substrates were doped with gold cations.

FIG. 5 is a graph of hydrogen production rate in (μmol/g_{catalyst}/min) versus time the iodide treated TiO₂ substrate was suspended in the HAuCl₄ solution.

### DETAILED DESCRIPTION OF THE INVENTION

While hydrogen-based energy from water has been proposed by many as a solution to the current problems associated with carbon-based energy (e.g., limited amounts and fossil fuel emissions), the currently available technologies are expensive, inefficient, and/or unstable. The present application provides a solution to these issues. The solution is predicated on the use of a photocatalyst having highly dispersed nanoparticles or sub-nanoparticles of electrically conductive materials on the surface of a photoactive material that has been treated with iodide ions. This combination of electrically conductive materials and a photoactive material results in the efficient production of hydrogen and oxygen in a water-splitting reaction by catalyzing hydrogen atom recombination to form H₂ and reducing electron hole recombination events.

These and other non-limiting aspects of the present invention are discussed in further detail in the following sections.

### A. Photoactive Catalysts

The photoactive material includes any semiconductor material able to be excited by light in a range from 360-600 nanometers. In a preferred embodiment, the photoactive material is titanium dioxide. Titanium dioxide can be in the form of three phases, the anatase phase, the rutile phase, and the brookite phase. Anatase and rutile phases have a tetragonal crystal system, whereas the brookite phase has an orthorhombic crystal system. While anatase and rutile both have a tetragonal crystal system consisting of TiO₆ octahedra, their phases differ in that anatase octahedras are arranged such that four edges of the octahedras are shared, while in rutile, two edges of the octahedras are shared. These different crystal structures result in different density of states (DOS) may account for the different efficiencies observed for transfer of charge carriers (electrons) in the rutile and anatase phases and the different physical properties of the catalyst. For example, anatase is more efficient than rutile in the charge transfer, but is not as durable as rutile. Each of the different phases can be purchased from various manufactures and supplies (e.g., titanium (IV) oxide anatase nano powder and titanium (IV) oxide rutile nano powder in a variety of sizes and shapes can be obtained from Sigma-Aldrich® Co. LLC (St. Louis, Mo., USA) and from Alfa Aesar GmbH & Co KG, A Johnson Matthey Company (Germany)); all phases of titanium dioxide from L.E.B. Enterprises, Inc. (Hollywood, Fla. USA)). They can also be synthesized using known sol-gel methods (See, for example, Chen et al., Chem. Rev. 2010 Vol. 110, pp. 6503-6570, the contents of which are incorporated herein by reference).

In one aspect of the invention, mixed phase titanium dioxide anatase and rutile may be a transformation product obtained from heat-treating single phase titanium dioxide anatase at selected temperatures. Heat-treating the single phase titanium dioxide anatase nanoparticle produces small particles of rutile on top of anatase particles, thus maximizing the interface between both phases and at the same time allowing for a large number of adsorbates (water and ethanol) to be in contact with both phases, due to the initial small particle size. Single phase TiO₂ anatase nanoparticles that are transformed into mixed phase TiO₂ nanoparticles have a surface area of about 45 to 80 m²/g, or 50 m²/g to 70 m²/g, or preferably about 50 m²/g. The particle size of these single phase TiO₂ anatase nanoparticles is less than 95 nanometers, less than 50 nm, less than 20, or preferably between 10 and 25 nm. Heat treating conditions can be varied based on the TiO₂ anatase particle size and/or method of heating (See, for example, Hanaor et al. in Review of the anatase to rutile phase transformation, J. Material Science, 2011, Vol. 46, pp. 855-874), and are sufficient to transform single phase titanium dioxide to mixed phase titanium dioxide anatase and rutile. Other methods of making mixed phase titanium dioxide materials include flame pyrolysis of TiCl₄, solvothermal/hydrothermal methods, chemical vapor deposition, and physical vapor deposition methods. Using a ratio of anatase to rutile of 1.5:1 or greater can substantially increase the photocatalytic activity of the semiconductor material. The mixed phase TiO₂ nanoparticles of the present invention can have a ratio of anatase and rutile phase ranges from 1.5:1 to 10:1, from 6:1 to 5:1, from 5:1 to 4:1, or from 2:1. As explained above, it is believed that this ratio allows for the efficient transfer of charge carriers (electrons) from the rutile phase to the anatase phase, where said charge carries in the anatase phase have an increased chance of being transferred to the metal conducting materials rather than undergoing an electron-hole recombination event.

The electrically conductive material can be a metal or metal alloy. Non-limiting embodiments of metals include gold, ruthenium, rhenium, rhodium, palladium, silver, copper, osmium, iridium, platinum, or any combination thereof. In some instances, the electrically conductive material is a plasmon resonance material. Non-limiting embodiments of plasmon resonance materials include silver, gold, copper, and palladium.

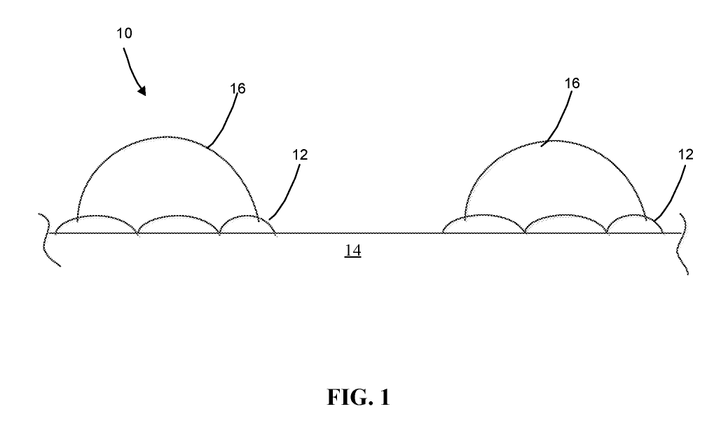

Referring to FIG. 1, a schematic of a surface of a photocatalyst of the present invention is depicted. Photocatalyst 10 can have iodide ions 12 between a photoactive material (for example, titanium dioxide particle) 14 and electrically conductive material 16. The photocatalyst 10 can be prepared from a photoactive material, an iodide ion source, and an electrically conductive material (e.g., metal) source. The number of iodide ions associated with the electrically conductive particles balances the valence of the electrically conductive particle. In a preferred embodiment, the electrically conductive particle 16 represent an Au⁺³ cation associated with three iodide ions 12. In other embodiments, Au⁺¹, Au⁺², or a different electrically conductive material having a valence of +1 or +2, can be associated with one iodide ion 12 or two of the iodide ions 12, respectively. Without wishing to be bound by theory, it is believed that the iodide ions inhibit agglomeration of the metal particles and, thus allow smaller particles of the metal to be dispersed on the surface of the catalysts while leaving sufficient surface area for the catalysis of water-splitting. In the embodiment shown, the photoactive material 14 has a generally circular cross-section. The photoactive material 14 can additionally be of any shape compatible with function in the photocatalyst 10 of the present invention, including but not limited to spherical, rod-shaped, irregularly shaped, or combinations thereof. The photoactive material 14 can also be, as non-limiting examples, a bulk material, a particulate material, or a flat sheet. The photoactive material 14 can be of any microstructure or larger size suitable for use in the photocatalyst system 10. In some embodiments, the photoactive material 14 are microstructures, meaning that they have at least one dimension measuring between 0.1 and 100 μm and no dimensions measuring 0.1 μm or less. Attachment of the electrically conductive material and the iodide ions to the photoactive material can be accomplished, for example, by contacting an iodide modified photoactive material with metal ions using the methods described in the Examples section and throughout this Specification. A non-limiting embodiment of a method that can be used to make the photocatalyst 10 of the present invention includes formation of an aqueous solution of metal iodide (for example, potassium iodide) and adding photoactive material to the solution (for example, adding titanium dioxide particles) to form a suspension. The suspension of photoactive material and metal iodide can be stirred for a desired amount of time (for example, 0.5, 1, 2, 10, 15, 20, or 24 hours) or until sufficient iodide ions are deposited on the surface of the photoactive material or in the interstitial spaces of the photoactive material's crystal lattice. The iodide modified photoactive material can be separated from the aqueous metal iodide solution using known techniques such as filtration, vacuum filtration, centrifugation or the like. The iodide modified photoactive material can be added to an aqueous solution of a salt of the electrically conductive material (for example, aqueous solution of HAuCl₄) for a desired amount of time to deposit the desired amount of the electrically conductive material on the iodide modified photoactive material. In non-limiting embodiments, the photoactive material is contacted with the electrically conductive material for 0.1 min., 0.5 min., 1 min., 1.25 min., 1.5 min., 1.75 min., 2 min., 2.25 min., 2.5 min., 2.75 min., 3 min. 3.25 min., 3.5 min., 3.75 min., 4 min., 4.25 min., 4.5 min., 4.75 min., 5.0 min., 5.25 min., 5.5 min. 5.75 min., 6.0 min., 6.25 min., 6.5 min., 6.75 min., 7.0 min., 7.25 min., 7.5 min., 7.75 min., 8.0 min., 8.25 min., 8.5 min., 8.75 min., 9.0 min. 9.25 min., 9.75 min., 10.0 min., 20 min., 30 min., 60 min., or any range derivable therein. In non-limiting embodiments, the amount of electroconductive material deposited on the surface can be 0.0500 wt. %, 0.0525 wt. %, 0.0550 wt. %, 0.0575 wt. %, 0.0600 wt. %, 0.0625 wt. %, 0.0650 wt. %, 0.0675 wt. %, 0.0700 wt. %, 0.0725 wt. %, 0.0750 wt. %, 0.0775 wt. %, 0.0800 wt. %, 0.0825 wt. %, 0.0850 wt. %, 0.0875 wt. %, 0.0900 wt. %, 0.0925 wt. %, 0.0950 wt. %, 0.0975 wt. %, 0.1000 wt. %, 0.1250 wt. %, 0.1500 wt. %, 0.1750 wt. %, 0.2000 wt. %, 0.2250 wt. %, 0.2500 wt. %, 0.2750 wt. %, 0.3000 wt. %, 0.3250 wt. %, 0.3500 wt. %, 0.3750 wt. %, 0.4000 wt. %, 0.4250 wt. %, 0.4500 wt. %, 0.4750 wt. %, 0.5000 wt. %, 0.5250 wt. %, 0.0550 wt. %, 0.5750 wt. %, 0.6000 wt. %, 0.6250 wt. %, 0.6500 wt. %, 0.6750 wt. %, 0.7000 wt. %, 0.7250 wt. %, 0.7500 wt. %, 0.7750 wt. %, 0.8000 wt. %, 0.8250 wt. %, 0.8500 wt. %, 0.8750 wt. %, 0.9000 wt. %, 0.9250 wt. %, 0.9500 wt. %, 0.9750%, up to 1.0%, or any range derivable therein, based on the total weight of the photocatalyst, of electrically conductive material. In preferred non-limiting embodiments, the amount of electroconductive material deposited on the surface of the iodide modified photoactive material can be 0.0500 wt. %, 0.0525 wt. %, 0.0550 wt. %, 0.0575 wt. %, 0.0600 wt. %, 0.0625 wt. %, 0.0650 wt. %, 0.0675 wt. %, 0.0700 wt. %, 0.0725 wt. %, 0.0750 wt. %, 0.0775 wt. %, 0.0800 wt. %, 0.0825 wt. %, 0.0850 wt. %, 0.0875 wt. %, 0.0900 wt. %, 0.0925 wt. %, 0.0950 wt. %, 0.0975 wt. %, 0.1000 wt. %, 0.1250 wt. %, 0.1500 wt. %, 0.1750 wt. %, 0.2000 wt. %, or any range derivable therein, based on the total weight of the photocatalyst, of electrically conductive material. In other non-limiting embodiments, the photoactive material is contacted with the electrically conductive material for 0.1 min., 0.5 min., 1 min., 1.25 min., 1.5 min., 1.75 min., 2 min., 2.25 min., 2.5 min., 2.75 min., 10 min or any range derivable therein and 0.0500 wt. %, 0.0525 wt. %, 0.0550 wt. %, 0.0575 wt. %, 0.0600 wt. %, 0.0625 wt. %, 0.0650 wt. %, 0.0675 wt. %, 0.0700 wt. %, 0.0725 wt. %, 0.0750 wt. %, 0.0775 wt. %, 0.0800 wt. %, 0.0825 wt. %, 0.0850 wt. %, 0.0875 wt. %, 0.0900 wt. %, 0.0925 wt. %, 0.0950 wt. %, 0.0975 wt. %, 0.1000 wt. %, 0.1250 wt. %, 0.1500 wt. %, 0.1750 wt. %, 0.2000 wt. %, or any range derivable therein, based on the total weight of the photocatalyst, of electrically conductive material is deposited on the iodide modified photoactive material. Without wishing to be bound by theory, it is believed that the metal cation attaches to the iodide ions through ionic bonding. Adjusting the time period, controls the amount of metal cation that is available for ionic bonding. Furthermore, when gold is used as the electrically conductive material, due to the ionic bonding of the Au (III) cation (electrically conductive material) with three iodide ions (I⁻), the gold does not require thermal reduction to elemental gold prior to use as the Au (III) can catalyze the recombination of hydrogen atoms.

### B. Water-Splitting System

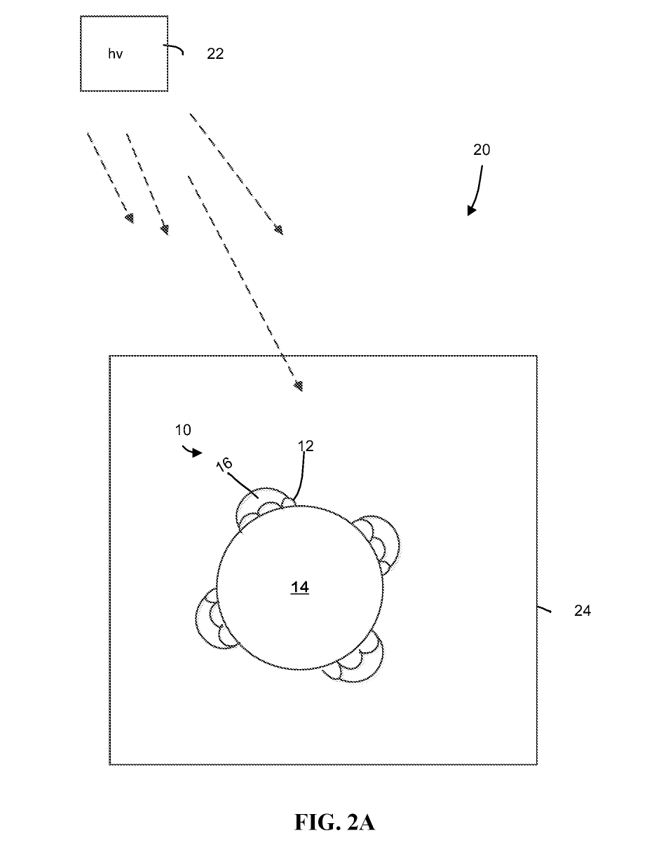

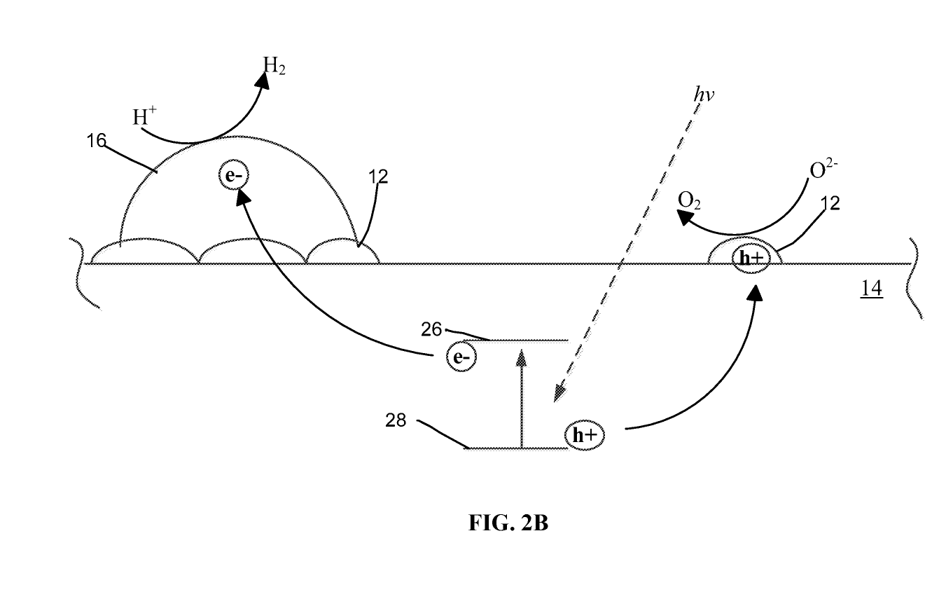

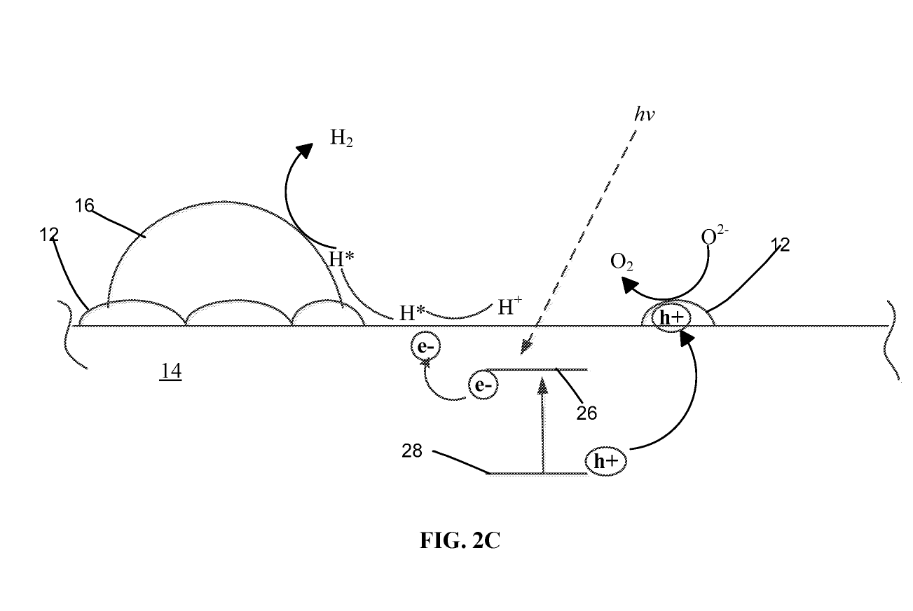

Referring to FIGS. 2A-C, a non-limiting representation of a water-splitting system 20 of the present invention is provided. The system includes the photocatalyst 10, a light source 22, and container 24. The photocatalyst includes electrically conductive material 16 attached (bonded) to the iodide ions 12 which are attached or dispersed on the photoactive material 14. The container 24 can be a transparent, translucent or even opaque such as those that can magnify light (e.g., opaque container having a pinhole(s)). The photocatalyst 10 can be used to split water to produce H₂ and O₂. The light source 22 includes visible and (400-600 nm) and ultraviolet light (360-410). The ultraviolet light excites the photoactive material 14 while the visible light excites “resonance” electrons from Au (and/or Ag) atoms (plasmonic excitation). Referring to FIGS. 2B and 2C the pathways for production of hydrogen and water are depicted. In both pathways, the excited electrons (e−) transition from their valence band 26 to their conductive band 28 thereby leaving a corresponding hole (h+). In the first pathway shown in FIG. 2B, the excited electrons (e−) can be transferred to the electrically conductive material where reduction of hydrogen ions on the surface of the metal occurs through electron transfer to form molecular hydrogen (H₂). The holes (h+) are used to oxidize oxygen ions to molecular oxygen (O₂). In the second pathway shown in FIG. 2C, the excited electrons (e−) can be reduced to hydrogen atoms at the surface of the photoactive material. The hydrogen atoms migrate to the metal surface where the electrically conductive material 16 can catalyze the recombination of the hydrogen atoms to molecular hydrogen (H₂). The holes (h+) are used to oxidize oxygen ions to oxygen gas. In both pathways, the hydrogen gas and the oxygen gas can then be collected and used in other processes. Without wishing to be bound to theory, it is believed that both pathways can exist in a photocatalytic system, however, the catalysis pathway (FIG. 2B) is about 100 to 1000 times faster than that of electron transfer pathway (FIG. 2A). Due to the electrically conductive material 16 having small particle sizes and being highly dispersed on the surface of the photoactive material 14, excited electrons (e−) are more likely to be used to split water before recombining with a hole (h+) than would otherwise be the case. Notably, the system 20 does not require the use of an external bias or voltage source. Further, the efficiency of the system 20 allows for one to avoid or use minimal amounts of a sacrificial agent such as methanol, ethanol, propanol, butanol, isobutanol, methyl tert-butyl ether, ethylene glycol, propylene glycol, glycerol, oxalic acid, triethylamine, triethanolamine, or any combination thereof. In certain aspects, however, 0.1 to 10 w/v %, or preferably 2 to 7 w/v %, of a sacrificial agent can be included in the aqueous solution. The presence of the sacrificial agent can increase the efficiency of the system 20 by further reducing the likelihood of hole/electron recombination via oxidation of the sacrificial agent by the hole rather than recombination with the excited electron. Preferred sacrificial agents ethylene glycol, glycerol, or a combination thereof is used. In addition to being capable of catalyzing water splitting without an external bias or voltage, the photocatalysts of the present invention may be included in an anode of an electrochemical cell capable of forming oxygen and hydrogen by electrolysis of water. In a non-limiting embodiment, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light energy or light flux. For example, the photoactive catalyst 10 can be used as the anode in a transparent container containing an aqueous solution and used in a water-splitting system. An appropriate cathode can be used such as Mo-Pt cathodes (See, International Journal of Hydrogen Energy, June 2006, Vol. 31, issue 7, pages 841-846, the contents of which are incorporated herein by reference) or MoS₂ cathodes (See, International Journal of Hydrogen Energy, February 2013, Vol. 38, issue 4, pages 1745-1757, the contents of which are incorporated herein by reference).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Production of Photocatalysts of the Present Invention

I⁻/TiO₂ Substrate.

The iodide ion modified titanium dioxide substrate (I⁻/TiO₂) was made using a treatment method to obtain iodide ions coated on the surface of the titanium dioxide anatase phase substrate. A solution of potassium iodide (10 mM KI) was prepared by dissolving potassium iodide (KI, 350 mg) into deionized water (210 mL). The TiO₂ (3.0 g) was added to the aqueous KI solution to form a suspension. The suspension was stirred for about 12 hours (overnight). The suspension was vacuum filtered and the iodide ion modified TiO₂ particles were stored.

Au⁺³/I⁻/TiO₂ Photocatalyst.

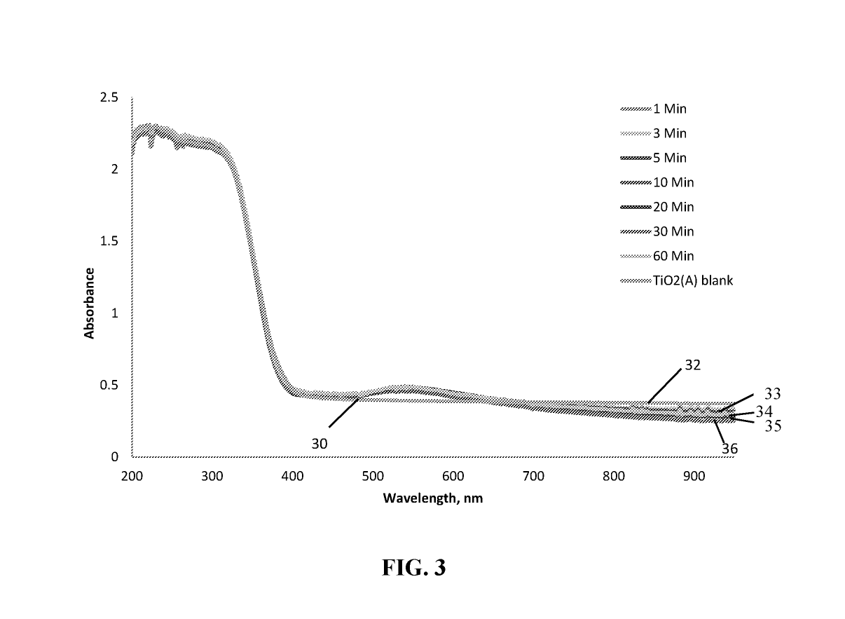

A solution of hydrogen chloroauric acid (HAuCl₄, Sigma-Aldrich®) was obtained commercially. Iodide modified TiO₂ particles (1 gram) were added to the HAuCl₄ solution for each catalyst prepared and contacted for different periods of deposition time (1 min, 3, minutes, 5 minutes, 20 minutes, 30 minutes, and 60 minutes). The suspensions were sonicated for 1 to 3 minutes. At the end of the contact time period, the solution was vacuum filtered using a fine filter and then washed with excess deionized water to obtain the gold iodide modified titanium dioxide (Au⁺³/I⁻/TiO₂) photocatalysts. The photocatalysts were dried at 70° C. overnight (about 12 hours). FIG. 3 are spectra of UV-Vis absorption of Au⁺³/I⁻/TiO₂ of the invention made by contact times the iodide I⁻/TiO₂ with Au⁺³ for 5 min., 10 min., 20 min., 30 min. and 60 min. Data line 30 is the TiO₂ reference with no doping and data lines 31, 32, 33, 34, 35 are the I⁻/TiO₂ with Au⁺³ for 5 min, 10 min., 20 min., 30 min. and 60 minutes respectively, photocatalysts versus wavelength. As shown by the spectra in FIG. 3, the Au⁺³/I⁻/TiO₂ all of photocatalysts exhibited a strong plasmon resonance (i.e., strong Au absorption between 500 and 600 nm.) The amount of gold on the surface of each Au⁺³/I⁻/TiO₂ photocatalysts was determined using X-ray photoelectron spectroscopy (XPS). The gold weight percent on the surface after 10 minutes of deposition was found to be about 0.6 wt. %, while the gold deposited on the surface after 30 minutes was 0.9 wt. %. The amount of gold in the bulk of each Au⁺³/I⁻/TiO₂ was determined by elemental analysis utilizing inductively coupled plasma (ICP). The gold weight percent in the bulk for the photocatalysts was 0.5 wt. %.

### Example 2

### Use of the Photocatalysts of the Invention in Water-Splitting Reactions

Water-Splitting Reaction Using Example 1 Photocatalysts.

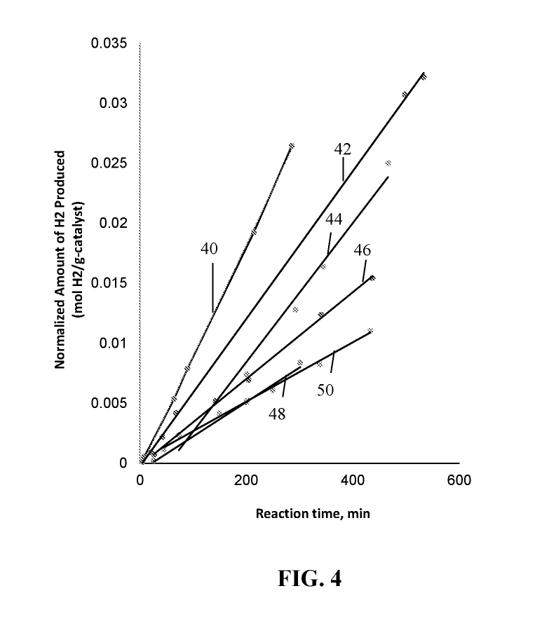

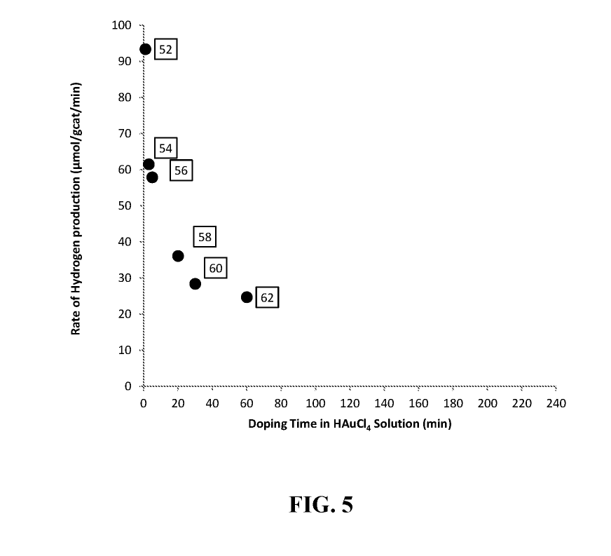

Catalytic reactions were conducted in a borosilicate (Pyrex®, Corning) glass reactor having a capacity of 100 mL. A photocatalyst prepared as described in Example 1 was added to the glass reactor in a concentration of 0.1 g/L (10 mg in 21 mL total volume). Deionized water (20 mL) and sacrificial agent (ethanol, 5 v/v % based on total water, 1 mL) were added to the reactor. The reaction mixture was irradiated with sunlight, with a light flux at the front side of the reactor of between 2 to 10 mW/cm² at 360 nm. The mixture containing photocatalyst, water and sacrificial agent was stirred constantly under dark conditions to disperse the catalyst and sacrificial agent in the water. The reactor was then exposed to a UV light source (100 Watt UV lamp (H-144GC-100, Sylvania par 38) with a flux of about 2-5 mW/cm2 at a distance of 10 cm with the cut off filter (360 nm and above). Product analysis of the produced gas was done using a gas chromatography (Porapak™ Q (Sigma Aldrich) packed column 2 m, 45° C. (isothermal), with nitrogen as a carrier gas) with a thermal conductivity detector. FIG. 4 is a graph of hydrogen production versus time that for the iodide treated TiO₂ (anatase) substrates doped with gold cations for 5 min., 20 min., 30 min. and 60 min. Data 40 represents hydrogen production using a Au⁺³/I⁻/TiO₂ photocatalyst made at 1 min. deposition time optimization (DTO), data 42 represents hydrogen production using a Au⁺³/I⁻/TiO₂ photocatalyst made at 3 min. DTO, data 44 represents hydrogen production using a Au⁺³/I⁻/TiO₂ photocatalyst made at 5 min. DTO, data 46 represents hydrogen production using a Au⁺³/I⁻/TiO₂ photocatalyst at 20 min. DTO, data 48 represents hydrogen production using a Au⁺³/I⁻/TiO₂ photocatalyst at 30 min. DTO, and 50 represents hydrogen production using a Au⁺³/I⁻/TiO₂ photocatalyst at 60 min. DTO. The Au⁺³/I⁻/TiO₂ photocatalyst having a 30 minute DTO had a gold content of 0.9 wt. %. FIG. 5 is a graph of hydrogen production rate in (μmol/g_{catalyst}/min) versus time that the iodide treated TiO₂ substrate was suspended in the HAuCl₄ solution. Data 52 represents hydrogen production after 1 min. DTO, data 54 represents hydrogen production after 3 min. DTO, data 56 represents hydrogen production after 5 min. DTO, data 58 represent hydrogen production after 20 min. DTO, data 60 represents hydrogen production after 30 min. DTO, and data 62 represents hydrogen production after 60 min. DTO. Table 1 is a listing of the deposition time in minutes and the hydrogen production in μmol/g_{catalyst}/min. for FIG. 5. From the data in FIGS. 4 and 5 and Table 1, it was concluded that a greater increase in hydrogen gas production was observed for catalysts that had the shorter deposition time. For example, the hydrogen production using the catalyst prepared by soaking iodide treated TiO₂ substrate in the HAuCl₄ solution for 1 minute is greater than the hydrogen product using the catalyst prepared by soaking the iodide treated TiO₂ substrate in HAuCl₄ solution for 60 minutes.

TABLE 1

| Deposition Time | Hydrogen (H₂) Production |
|---|---|
| (minutes) | (μmol/g_{catalyst}/min) |
| 1 | 93.4 |
| 3 | 61.5 |
| 5 | 57.9 |
| 20 | 36.1 |
| 30 | 28.4 |
| 60 | 24.7 |

1. A photocatalyst comprising:
a) a photoactive material comprising titanium dioxide and iodide ions attached to the surface of the titanium dioxide; and
b) an electrically conductive material attached to the iodide ions,
wherein the electrically conductive material includes a metal cation.

2. The photocatalyst of claim 1, wherein the metal is gold.

3. The photocatalyst of claim 2, wherein the gold is gold cations and ionic bonds are formed between the iodide ions and gold cations.

4. The photocatalyst of claim 3, comprising less than 1 wt. % of gold.

5. The photocatalyst of claim 4, wherein the gold is in the form of particles having an average particle size of ≦1 nm to 10 nm.

6. The photocatalyst of claim 1, wherein the titanium dioxide comprises anatase, rutile, brookite or a mixture thereof.

7. The photocatalyst of claim 6, wherein the titanium dioxide comprises single phase anatase.

8. The photocatalyst of claim 6, wherein the titanium dioxide comprises anatase and rutile, and the ratio of anatase to rutile ranges from 4:1 to 5:1.

9. (canceled)

10. The photocatalyst of claim 1, wherein the metal is platinum.

11. The photocatalyst of claim 1, wherein the metal is gold, ruthenium, rhenium, rhodium, palladium, silver, copper, osmium, iridium, platinum, or combinations thereof.

12. The photocatalyst of claim 11, wherein the metal is gold, palladium, or a combination thereof.

13. The photocatalyst of claim 1, wherein the electrically conductive material has an average particle size of 1 nm to 10 nm.

14-17. (canceled)

18. The photocatalyst of claim 1, wherein the photocatalyst is uncalcined.

19-20. (canceled)

21. A method for producing hydrogen gas and oxygen gas from water, the method comprising obtaining a water-splitting photocatalyst of claim 1 and subjecting the composition to the light source for a sufficient period of time to produce hydrogen gas from the water.

22-24. (canceled)

25. A method of making the photocatalyst of claim 1, the method comprising:
a) obtaining an iodide modified titanium dioxide having iodide ions attached to the surface of the titanium dioxide; and
b) treating the iodide modified titanium dioxide with a metal salt solution comprising a metal salt solubilized in a solvent to form metal cations attached to the iodide ions to obtain the photocatalyst.

26. The method of claim 25, wherein the iodide treated titanium dioxide is suspended in the metal salt solution.

27. The method of claim 26, wherein a particle size of the metal cation is proportional to the amount of time the titanium dioxide is suspended in the metal salt solution and wherein the amount of time the titanium dioxide is suspended in the metal salt solution is 1 to 5 minutes.

28. The method of claim 25, wherein the iodide treated titanium dioxide from step a) is obtained by treating titanium dioxide with an iodide solution comprising an iodide solubilized in a second solvent to form iodide ions attached to the surface of the titanium dioxide.

29. The method of claim 28, wherein the titanium dioxide is suspended in the iodide solution for 1 to 48 hours.

30. (canceled)

31. The method of claim 25, wherein the produced photocatalyst is not subjected to a calcination treatment.

32. (canceled)

33. (canceled)
